(19) United States
(12) Patent Application Publication
(10) Pub. No.: US 2009/0165911 A1
(43) Pub. Date: Jul. 2, 2009

(54) PNEUMATIC TIRE

(75) Inventor: Toshiyuki Ohashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd, Osaka (JP)

(21) Appl. No.: 12/275,280

(22) Filed: Nov. 21, 2008

(30) Foreign Application Priority Data
Dec. 28, 2007 (JP) 2007-340577

(51) Int. Cl. B60C 11/13

(52) U.S. Cl. 152/209.25; 152/209.18

(57) ABSTRACT

An object of the present invention is to provide a pneumatic tire capable of reducing the narrowing of the openings of sipes and increasing ground-contact performance by ensuring the edge effect and the water removal effect thereby increasing on-ice braking performance while providing a satisfactory durability to a sipe-forming blade mounted on the tire manufacturing die. To achieve the above object, each of the sipes formed in a land portion of a tread surface which a pneumatic tire comprises has: a first sipe portion in which a first wide portion having a bottom portion thereof is formed, a second sipe portion in which a second wide portion having a bottom portion thereof and extending in a depth direction from a depth position closer to the tread surface side than the bottom portion of the first wide portion is formed at the side opposite to the first wide portion as viewed in a sipe width direction, the second sipe portion being positioned on the side of the bottom portion of the first sipe portion, and a third sipe portion in which a third wide portion having a bottom portion thereof and extending in a depth direction from a depth position closer to the tread surface side than the bottom portion of the second wide portion is formed at the same side as the first wide portion as viewed in a sipe width direction, the third sipe portion being positioned on the side of the bottom portion of the second sipe portion.

### BACKGROUND OF THE INVENTION

1. Field of the Invention

The present invention relates to a pneumatic tire, comprising a tread surface including a land portion in which a plurality of sipes are formed. The pneumatic tire is particularly useful as a studless tire.

2. Description of the Related Art

Conventionally, in studless tires, a land portion such as a block, a rib and the like is formed with cuts called sipes. With edge effect and water removal effect that are obtained with the sipes, the driving performance of a vehicle is enhanced on snow-covered/iced load surfaces having small friction coefficient. As such sipes, a straight sipe extending linearly in a length direction of the sipe, a wave sipe extending in a wave-like configuration and the like have been put into actual use.

Generally, rubbers have incompressibility. Therefore when a load is applied to a tire, a tread surface thereof coming into contact with a road surface deforms largely causing the openings of the sipes to be closed. Particularly, on a snow-covered/iced load surface or the like having a low friction coefficient, due to slippage, the tread surface is largely deformed and sipes tend to be closed causing the openings to be narrowed. As a result, the edge effect and the water removal effect that the sipes are expected to exert may decrease.

In order to solve such problem, the inventors of the present invention have proposed a pneumatic tire formed with the following sipes. That is, each of the sipes has a plurality of wide portions extending in a sipe length direction. The wide portions thereof are disposed alternately at the both sides of the sipe as viewed in a sipe width direction (refer to Japanese Unexamined Patent Publication No. 2007-8303). In this pneumatic tire, tread rubber is easily bent in the sipe depth direction. Therefore, when a load is applied to the tire, the deformation due to the load can be absorbed with the wide portions. Therefore, the narrowing of the sipe openings can be reduced. As a result, the edge effect and the water removal effect are ensured and thus the on-ice braking performance can be increased.

However, the inventors of the present invention further examined and found the following fact. In order to form sipes having the above-described wide portion, sipe-forming blades are mounted on a tire-manufacturing die. FIG. 5 conceptually illustrates a sipe-forming blade. The sipe-forming blade has thick portions T1 and T2 for forming wide portions, which extend in the depth direction. A thick portion T2 is disposed at the opposite side of a thick portion T1 as viewed in a blade width direction. The thick portion T2 extends from a depth position same as the depth position “P” of the bottom portion of the thick portion T1. Therefore, the sipe-forming blade includes a thin portion in the blade width direction at the depth position P. With the repeated vulcanization, stress is intensively built up in the vicinity of the thin portion at the depth position P of the blade. As a result, the blade may be bent or broken. From this fact, the inventors of the present invention found that there is a room for further improving the sipe-forming blade, when a satisfactory durability is to be provided to the sipe-forming blade mounted on the tire-manufacturing die, while increasing the on-ice braking performance (braking performance on snow-covered/iced load surface) of pneumatic tires.

### SUMMARY OF THE INVENTION

The present invention has been proposed in view of the above-described circumstances. An object of the present invention is to provide a pneumatic tire capable of reducing the narrowing of the openings of sipes and increasing ground-contact performance by ensuring the edge effect and the water removal effect thereby increasing on-ice braking performance while providing a satisfactory durability to a sipe-forming blade mounted on the tire manufacturing die.

The above-mentioned object can be achieved by the present invention as follows. That is, the present invention provides a pneumatic tire, comprising a tread surface including a land portion in which a plurality of sipes are formed, wherein each of the sipes has: a first sipe portion in which a first wide portion having a bottom portion thereof is formed, a second sipe portion in which a second wide portion having a bottom portion thereof and extending in a depth direction from a depth position closer to the tread surface side than the bottom portion of the first wide portion is formed at the side opposite to the first wide portion as viewed in a sipe width direction, the second sipe portion being positioned on the side of the bottom portion of the first sipe portion, and a third sipe portion in which a third wide portion having a bottom portion thereof and extending in a depth direction from a depth position closer to the tread surface side than the bottom portion of the second wide portion is formed at the same side as the first wide portion as viewed in a sipe width direction, said third sipe portion being positioned on the side of the bottom portion of the second sipe portion.

According to the pneumatic tire of the present invention, the sipe is arranged so as to have the plurality of wide portions, which are arranged, in the sipe depth direction, alternately at the both sides of the sipe as viewed in the sipe width direction. Therefore, the tread rubber can be easily bent in the sipe depth direction. When a load is applied to the tire, the wide portions can absorb the deformation of the tread rubber due to the load. With this arrangement, the narrowing of the openings of the sipes is reduced. The edge effect and the water removal effect are ensured and the ground-contact performance is increased and thereby the on-ice braking performance is increased. Further, since the respective wide portions have their bottom portion, the rigidity of the land portion is prevented from decreasing too much.

The first sipe portion has a portion that is shared, in the depth direction, by the second sipe portion positioned at the bottom side of the first sipe portion. Likewise, the second sipe portion has a portion that is shared, in the depth direction, by the third sipe portion. That is, each of the sipe portions has a portion that, in the depth direction, is shared by the other neighboring sipe portion. On the other hand, with this arrangement, in the sipe forming blade also, the thick portions for forming the wide portions of the sipe have portions that are shared, in the depth direction, by the neighboring thick portions. As a result, the sipe-forming blade has no thin portions in the blade width direction. Therefore, the durability of the sipe-forming blade can be satisfactorily ensured.

On the other hand, according to the above-described structure, in the sipe, large cavity portions are formed corresponding to the wide portions. The rigidity of the land portion, which is formed with such sipes, tends to be reduced. However, the sipes are arranged so that the open-ends thereof, which are opened to the groove portions formed on the tread surface, have a shallower depth. With this arrangement, the rigidity of the land portion can be prevented from being reduced too much. As a result, this arrangement can preferably increase not only the on-ice braking performance but also the on-dry road braking performance (braking performance on dry road surface).

In the above arrangement, it is preferred that the ratio between the depth of the wide portion formed in the deepest portion as viewed in the depth direction and the depth in the other wide portions is arranged to be 1.1 to 2. Ordinarily, when the tire wears and the height of the land portion decreases, the rigidity of the land portion increases from a middle stage to a final stage of the wear. However, the sipes are arranged so that the depth of the wide portion, which is formed in the deepest portion of the sipe as viewed in the depth direction, to be larger than the depth of other wide portions. Therefore, even after the middle stage of the wear, the rigidity of the land portion is reduced and the land portion can be easily bent. As a result, even after the middle stage of the wear, the yielding of the land portion can be ensured. Therefore, the on-ice braking performance and the like can be satisfactorily obtained.

### BRIEF DESCRIPTION OF THE DRAWINGS

FIG. 1 is an expansion plan showing an example of a tread surface of a pneumatic tire according to the present invention;

FIG. 2 is an enlarged view of FIG. 1 showing an opening of a sipe;

FIG. 3 is a sectional view on A-A in FIG. 2 as viewed in the direction of the arrows;

FIG. 4 shows an inner wall surface of the sipe; and

FIG. 5 is a sectional view showing an example of a sipe-forming blade mounted on a tire-manufacturing die.

### DETAILED DESCRIPTION OF THE PREFERRED EMBODIMENTS

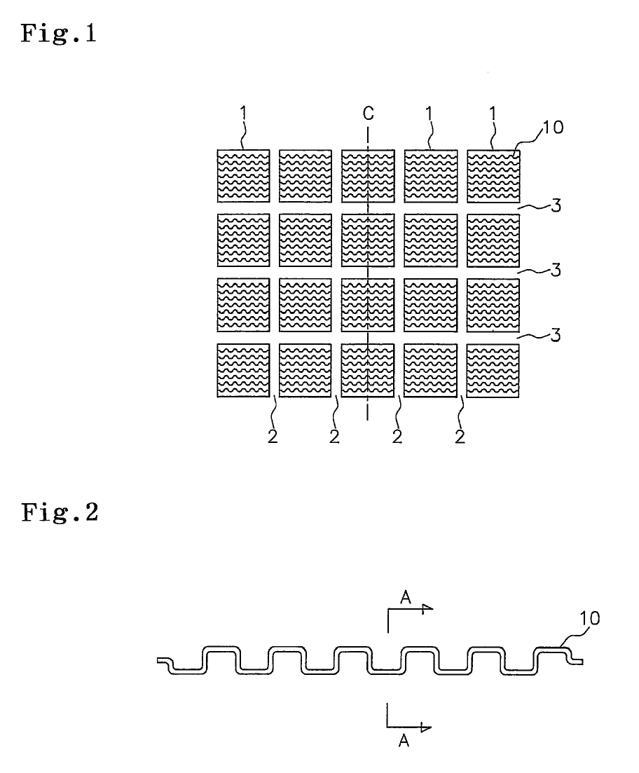

An embodiment of the present invention will be described below with reference to the accompanying drawings. FIG. 1 is an expansion plan view illustrating an example of a tread surface of a pneumatic tire according to the present invention. The pneumatic tire has a tread pattern including a plurality of blocks 1 (an example of land portion). The block 1 is sectioned with Groove portions 2 extending in a circumferential direction of the tire and lateral groove portions 3 extending in a width direction of the tire. In the tread surface, five rows of the blocks 1 are arranged symmetrically with respect to an equatorial line C of the tire.

Each of the blocks 1 is formed with a plurality of sipes 10 (seven in this embodiment) at predetermined intervals. Each of the sipes 10 has a wave-like opening as shown in FIG. 2. In wave sipes each having a wave-like opening, compared to straight sipes each having a straight opening, the openings of the sipes are hardly narrowed. Therefore, in addition to the above-mentioned effect to reduce the narrowing of openings with the wide portions, edge effect and water removal effect with the sipes can be ensured effectively and the yielding of the blocks 1 on dry road surface can be reduced.

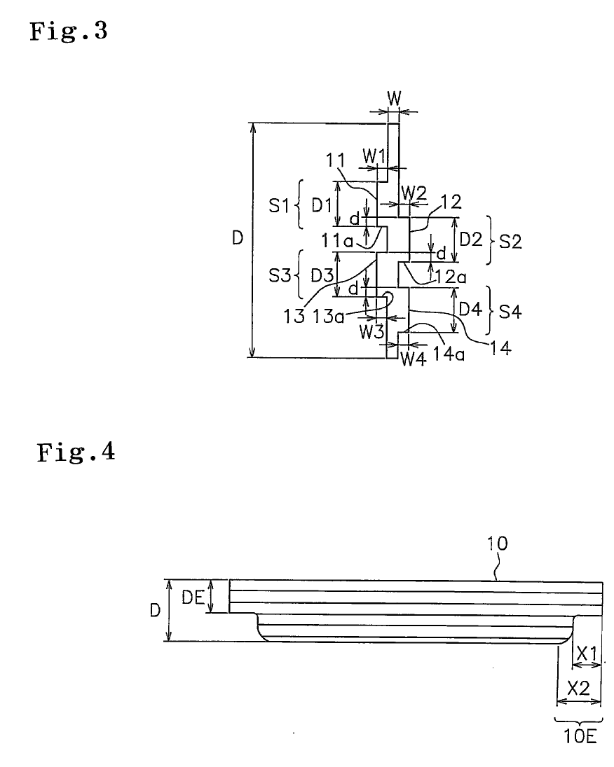

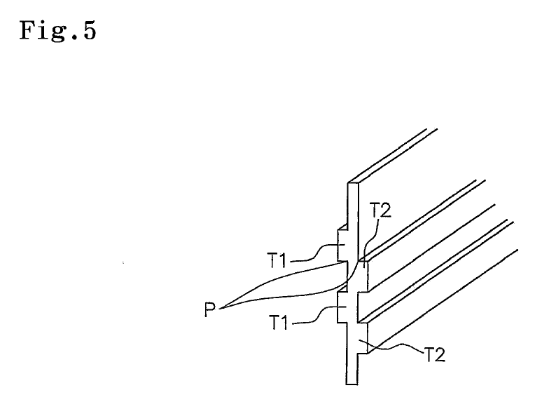

FIG. 3 is a sectional view of the sipe 10 on A-A in FIG. 2 as viewed in a direction of arrows. In FIG. 3, a vertical direction is a depth direction of the sipe 10 and a horizontal direction is a width direction of the sipe 10. In this embodiment, the sipe 10 is constituted of a first sipe portion S1, a second sipe portion S2, a third sipe portion S3, and a fourth sipe portion S4. The first sipe portion S1 has a first wide portion 11; the second sipe portion S2 has a second wide portion 12; the third sipe portion S3 has a third wide portion 13; and the fourth sipe portion S4 has a fourth wide portion 14.

The first wide portion 11 extends toward the left side in FIG. 3. The second wide portion 12 extends toward the right side in FIG. 3. The first wide portion 11 and the second wide portion 12 are disposed at the different sides opposite to each other in a sipe width direction. The third wide portion 13 extends toward the left side in FIG. 3 and is disposed at the same side as the first wide portion 11 in the sipe width direction. The fourth wide portion 14 extends toward the right side in FIG. 3 and is disposed at the side opposite to the side of the first wide portion 11 as viewed in the sipe width direction. That is, the first wide portion 11, the second wide portion 12, the third wide portion 13 and the fourth wide portion 14 are disposed at the both sides alternately in the sipe width direction along the depth direction of the sipe 10.

The first sipe portion S1, the second sipe portion S2, the third sipe portion S3 and the fourth sipe portion S4 are formed continuously in the depth direction of the sipe 10. The second portion S2 is positioned on the side of the sipe bottom portion 11a of the first sipe portion S1. The third sipe portion S3 is positioned on the side of the sipe bottom portion 12a of the second sipe portion S2. The fourth sipe portion S4 is positioned on the side of the sipe bottom portion 13a of the third sipe portion S3.

The second wide portion 12 extends in the depth direction from a depth position which is away from the bottom portion 11a of the first wide portion 11 by a distance “d” and is closer to the tread surface than the bottom portion 11a of the first wide portion 11. Likewise, the third wide portion 13 extends in the depth direction from a depth position which is away from the bottom portion 12a of the second wide portion 12 by a distance “d” and is closer to the tread surface than the bottom portion 12a of the second wide portion 12. Also, the fourth wide portion 14 extends in the depth direction from a depth position which is away from the bottom portion 13a of the third wide portion 13 by a distance “d” and is closer to the tread surface than the bottom portion 13a of the third wide portion 13. As a result, the first sipe portion S1 has a portion that is shared by the second sipe portion S2 positioned on the side of the bottom portion 11a with a distance “d” therebetween in the depth direction. Likewise, the second sipe portion S2 has a portion that is shared with the third sipe portion S3; and the third sipe portion S3 has a portion shared by the fourth sipe portion S4 in the depth direction.

As described above, each of the sipe portions has a portion that is shared by the neighboring other sipe portion with the distance “d” in the depth direction. Therefore, in a sipe-forming blade also, each of thick portions for forming the wide portion of the sipes has a portion that is shared by the neighboring thick portion with a thickness corresponding to the distance “d” in the width direction of the blade. As a result, in the sipe-forming blade there is no thin portion in the width direction thereof. Therefore, the durability of the sipe-forming blade can be satisfactorily ensured. In order to satisfactorily ensure the durability of the sipe-forming blade, the distance “d” of the portions shared by the respective sipe portions is preferably 0.2 mm to 0.5 mm; more preferably 0.3 mm to 0.4 mm.

When the first wide portion 11, the second wide portion 12, the third wide portion 13 and the fourth wide portion 14 are formed in the sipe as shown in FIG. 3, it is defined herein as below. That is, when depth of the first wide portion 11 is defined as “D1”; second wide portion 12 as “D2”; the third wide portion 13 as “D3”; and the fourth wide portion 14, which is disposed at the deepest portion of the sipe as viewed in the depth direction, as “D4”, it is preferred that the ratio between D4 and D1, D2 or D3 is 1.1 to 2 (more particularly, every one of the D4/D1, D4/D2 and D4/D3 is 1.1 to 2), more preferably 1.2 to 1.5. D1, D2 and D3 are preferably 1 mm to 2 mm, more preferably 1.2 mm to 1.6 mm. D4 is preferably 1.1 mm to 3 mm, more preferably 1.3 mm to 2 mm. Note that as to the wide portions, the depth refers to the distance, in the depth direction, from a point where the wide portion starts to the bottom portion thereof.

Defining the depth of the sipe 10 as “D”, in order to optimize the rigidity of the block 1 in accordance with the progression of wear, it is preferred that D1/D, D2/D and D3/D are within a range of 0.15 to 0.35; and D4/D is within a range of 0.2 to 0.4. Further, the depth “Z” ((sum of D1 to D4)−3 d) from a point where the first wide portion 11 starts to the bottom portion 14a of the fourth wide portion 14 is preferably within a range of 55% to 75% of the depth “D” of the sipe 10. When the depth “Z” is smaller than 55% of the depth “D” of the sipe 10, it may cause the effect to prevent the narrowing of the sipe opening to decrease. Contrarily, when the depth “Z” exceeds 75% of the depth “D” of the sipe 10, the capacity of the sipe is too large and the rigidity of the land portion becomes too small. As a result, the yielding of the land portion becomes too large. This may cause a reduction of the ground contact area of the land portion, thereby resulting in a reduction of the on-ice braking performance and the like.

The protruding height W1, W2, W3 and W4 of the first wide portion 11, the second wide portion 12, the third wide portion 13 and the fourth wide portion 14 is preferably 80% to 130% with respect to the width W of the sipe 10 (width of the opening). When the ratio is smaller than 80%, the effect to absorb deformation with the wide portion tends to decrease. When the ratio exceeds 130%, the rigidity of the block 1 decreases and the yielding becomes too large, thereby resulting in a decrease of the edge effect. As for actual dimensions, when the sipe width “W” is 0.3 mm to 0.5 mm, it is exemplified that the protruding height W1, W2, W3 and W4 is 0.2 mm to 0.5 mm, preferably 0.3 mm to 0.4 mm.

FIG. 4 shows an internal wall surface of the sipe 10 (concavity and convexity of the waveform is not shown). In this embodiment, the sipe 10 is arranged to have a depth “D” (depth at the center as viewed in the length direction) and a depth “DE” at both ends 10E of the opening, where the sipe 10 is opened to the groove portions 2 formed in the tread surface. That is, the sipe is arranged to have a shallower depth at the opening ends 10E which are opened to the groove portion 2 formed in the tread surface. This arrangement prevents the land portion 1 from decreasing the rigidity too much. As a result, the on-ice braking performance and the on-dry braking performance can be increased. In order to increase the on-ice braking performance and the on-dry braking performance while maintaining well-balance relations with each other, the length X1 of a flat bottom portion in the open ends 10E is preferably 1 mm to 3 mm. Further, the length X2 of the open ends 10E (the length of portion where the sipe depth is shallow; portion where the sipe depth is shallower than “D”) is preferably 2 mm to 4 mm.

As described above, according to the sipe structure of the present invention, when a load is applied to the tire, the first wide portion 11, the second wide portion 12, the third wide portion 13 and the fourth wide portion 14 can absorb the deformation due to the load. Thus, the opening of the sipes 10 is prevented from narrowing, so that the edge effect and the water removal effect can be ensured. Moreover, the second wide portion 12 and the fourth wide portion 14 are disposed on the side opposite to the side where the first wide portion 11 and the third wide portion 13 are disposed. The deformation can be absorbed in a well-balanced manner on the both sides as viewed in the sipe width direction, and furthermore the displacement of the disposition center of the sipes 10 can be reduced. Accordingly, the contact pressure can be maintained evenly and the performances such as the on-ice braking performance and the like are increased.

In the present invention, the length of the sipes par unit area in the block 1; i.e., the sipe density is preferably 0.05 mm/mm² or more. When the sipe density is less than 0.05 mm/mm², expected effects of the sipes 10 may not be obtained satisfactorily. In order to appropriately ensure the rigidity of the block 1, it is preferred that the sipe density is not greater than 0.2 mm/mm².

In this embodiment, an example of wave sipe has been described, in which the sipe 10 extends in a wave-like configuration in the longitudinal direction thereof. However, the present invention is not limited to the above example. Linear sipes extending linearly may be adopted.

The pneumatic tire of the present invention is the same as ordinary pneumatic tires except that the above-described sipes are formed in the land portion. Therefore, any of the conventionally well-known materials, configurations, structures, manufacturing methods and the like may be applied to the present invention.

The present invention may be applied to so-called summer tires. Since the tire of the present invention is superior in braking performance on iced road surface, the present invention may be particularly applied to studless tires (winter tires).

### Other Embodiments

(1) The tread pattern of the pneumatic tire according to the present invention is not particularly limited. Therefore, for example, in place of the rectangular block as viewed from the top, the present invention may be applied to a block having a V-shaped configuration or polygonal shape, curved shape or the like. In place of or in addition to the block, a rib, which extends in a linear or zigzag configuration along a circumferential direction of a tire, may be adopted. Additionally in the present invention, the above-described sipe structure may be adopted for all land portions within the tread pattern. However, the sipe structure may be adopted for a part of land portion only within the tread pattern.

(2) The above embodiment has described an example of the sipe that includes the first sipe portion, the second sipe portion, the third sipe portion and the fourth sipe portion each formed with the first wide portion, the second wide portion, the third wide portion and the fourth wide portion respectively. However, the sipe may include at least the first sipe portion, the second sipe portion and the third sipe portion formed with the first wide portion, the second wide portion and the third wide portion respectively.

(3) The above embodiment has described an example in which longitudinal direction of the sipe is parallel to the width direction of the tire. However, the present invention is not limited to the above example. The longitudinal direction of the sipe may be inclined with respect to the width direction of the tire. Further, in the above embodiment, an example has described, in which each of the wide portions extends at a point of a specific depth in the longitudinal direction of the sipe. However, the present invention is not limited to the above example. The wide portions may extend in a wave-like or zigzag configuration having amplitude of vibration in the depth direction.

Hereinafter, examples, which have the above-described structure and provide the effects of the present invention, will be described below. The evaluation of performance of tires was carried out as described below.

### (1) On-Ice Braking Performance Test

On the Comparative Example and Example, on-ice braking performance test was conducted as described below. That is, new tires were mounted on an actual vehicle (an FR sedan 3,000 cc class). The vehicle was driven on an iced road surface. At a speed of 40 km/h, brake was applied to activate ABS and braking distance was measured. The tests were conducted on the same tires twice; i.e., at a state of virgin tires and at a state of 45% worn tires. Defining the test result of the Comparative Example at virgin state as 100, the test results were represented with indexes. The larger value indicates the better on-ice braking performance.

### (2) On-Dry Braking Performance Test

On the Comparative Example and Example, on-dry braking performance test was conducted as described below. That is, new tires were mounted on an actual vehicle (an FR sedan 3,000 cc class). The vehicle was driven on a dry road surface (paved road). At a speed of 100 km/h, brake was applied to activate ABS and braking distance was measured. Defining test result of the Comparative Example as 100, the test results were represented with indexes. The larger value indicates the better on-dry road braking performance.

### (3) Durability Test of Sipe Forming Blade

Sipe forming blades were mounted on a tire-manufacturing die. Vulcanizing process was conducted 1000 times using the tire-manufacturing die. Sipe forming blades were visually checked whether bend or break generated therein. After carrying out the vulcanizing process 1,000 times, when no bend or break was found, the blades were assessed as “Good”, when any of bend or break was found, the blades were assessed as “Poor”.

### EXAMPLE

In a pneumatic tire (tire size 205/65R15) formed with wave sipes shown in FIGS. 2 to 4, the respective values of the wave sipes were set up as below; i.e., W=0.3, D=6.5, DE=3, d=0.3, D1=D2=D3=1.3, D4=1.5, W1=W2=W3=W4=0.3, X1=2 and X2=3.

### Comparative Example

A pneumatic tire having the same structure excepting the following points was used as the comparative sample. That is, the sipe depth in the open end portions of the groove portion formed in the tread surface and the sipe depth at the center were the same (D=DE=6.5); the respective sipe portions have no portion shared by the adjacent sipe portions as viewed in the depth direction (d=0); and the depth of the respective wide portions was the same (D1=D2=D3=D4=1.3). The results are shown in Table 1.

TABLE 1

| | | Comparative | |
|---|---|---|---|
| | | Example | Example |
| On-ice | Initial | 100 | 105 |
| braking | 45% worn | 100 | 105 |
| performance | | | |

| | | |
|---|---|---|
| On-dry road braking | 100 | 100 |
| performance (Initial) | | |
| Durability of sipe-forming | Poor | Good |
| blade | | |

As shown in Table 1, compared to the Comparative Example, in the Example, even when the wear has proceeded, the on-ice braking performance can be satisfactorily ensured. The reason of this is understood as described below. That is, the depth of the wide portion formed in the deepest portion of the sipe as viewed in the depth direction is arranged to be larger than the depth of the other wide portions. With this arrangement, even when the tire has been worn up to 45%, since the rigidity of the land portion is reduced, the land portion is easily bent. In the Example, the depth of the sipe is arranged to be shallower in the open end portions, which are open to the groove portions formed in the tread surface. Further, the respective sipe portions have a portions shared by adjacent sipe portions as viewed in the depth direction. With this arrangement, it is understood that the on-dry road braking performance is ensured and the durability of the sipe-forming blade is increased.

What is claimed is:

1. A pneumatic tire, comprising a tread surface including a land portion in which a plurality of sipes are formed, wherein
each of the sipes has:
a first sipe portion in which a first wide portion having a bottom portion thereof is formed,
a second sipe portion in which a second wide portion having a bottom portion thereof and extending in a depth direction from a depth position closer to the tread surface side than the bottom portion of the first wide portion is formed at the side opposite to the first wide portion as viewed in a sipe width direction, said second sipe portion being positioned on the side of the bottom portion of the first sipe portion, and
a third sipe portion in which a third wide portion having a bottom portion thereof and extending in a depth direction from a depth position closer to the tread surface side than the bottom portion of the second wide portion is formed at the same side as the first wide portion as viewed in a sipe width direction, said third sipe portion being positioned on the side of the bottom portion of the second sipe portion.

2. The pneumatic tire according to claim 1, wherein each of the sipes is arranged so that the depth in the open end portions thereof, which are opened to groove portions formed in the tread surface, is shallower than the other part.

3. The pneumatic tire according to claim 1, wherein the ratio between the depth of the wide portion formed in the deepest portion of the sipe and the depth of the other wide portions is 1.1 to 2 as viewed in the depth direction.
